(19) United States
(12) Patent Application Publication
(10) Pub. No.: US 2021/0382335 A1
(43) Pub. Date: Dec. 9, 2021

(54) LCD PANEL AND DISPLAY DEVICE

(71) Applicant: TCL China Star Optoelectronics Technology Co., Ltd., Shenzhen (CN)

(72) Inventor: Rentang ZHAO, Shenzhen (CN)

(73) Assignee: TCL China Star Optoelectronics Technology Co., Ltd., Shenzhen (CN)

(21) Appl. No.: 16/639,591

(22) PCT Filed: Dec. 23, 2019
(86) PCT No.: PCT/CN2019/127386

§ 371 Date: Feb. 17, 2020

(30) Foreign Application Priority Data
Dec. 4, 2019 (CN) 201911225452.9

(51) Int. Cl. G02F 1/1339; G02F 1/1335; G02F 1/1337

(52) U.S. Cl. CPC G02F 1/1339; G02F 1/133723; G02F 1/133512; G02F 1/133514

(57) ABSTRACT

The present disclosure provides a liquid crystal display (LCD) panel, including a color filter substrate, an array substrate, a frame sealant configured to connect the color filter substrate with the array substrate, and a plurality of liquid crystals disposed between the color filter substrate and the array substrate. An alignment film and a plurality of black matrices are disposed on the color filter substrate, a liquid-blocking area is near the frame sealant and is disposed between the black matrices and the alignment film, and the liquid-blocking area is made of a plurality of protrusions which are spaced apart from each other.

### FIELD

The present disclosure relates to the field of display panel, and more particularly, relates to a liquid crystal display (LCD) panel and a display device.

### BACKGROUND

In display panels, a liquid crystal alignment process needs to be realized by a polyimide (PI) film. After liquid PI is coated on a surface of a substrate, the liquid PI keeps flowing to a periphery of the substrate and is cured after a heating process is finished. However, an irregular flow of liquid PI at the periphery of the substrate could easily result in a wavy periphery, and the periphery of the panel needs to reserve sufficient space for the liquid PI because a width of the wavy periphery is usually about 1000 μm, thereby limiting a periphery design of products. As a result, a narrow bezel cannot be realized, and a utilization rate of a glass is low.

There are technical problems of overly wide bezels and low utilization rate of glass among conventional display panels.

### SUMMARY

The present disclosure provides a liquid crystal display (LCD) panel, including a color filter substrate, an array substrate, a frame sealant configured to connect the color filter substrate with the array substrate, and a plurality of liquid crystals disposed between the color filter substrate and the array substrate. An alignment film and a plurality of black matrices are disposed on the color filter substrate, a liquid-blocking area is near the frame sealant and is disposed between the black matrices and the alignment film, and the liquid-blocking area is made of a plurality of protrusions which are spaced apart from each other. At least two columns of the protrusions are disposed in the LCD panel, a gap is disposed between the at least two columns of the protrusions, and a height difference does not exist or exists between adjacent protrusions.

The present disclosure further provides an LCD panel, including a color filter substrate, an array substrate, a frame sealant configured to connect the color filter substrate with the array substrate, and a plurality of liquid crystals disposed between the color filter substrate and the array substrate. An alignment film and a plurality of black matrices are disposed on the color filter substrate, a liquid-blocking area is near the frame sealant and is disposed between the black matrices and the alignment film, and the liquid-blocking area is made of a plurality of protrusions which are spaced apart from each other.

The present disclosure further provides a display device, including a liquid crystal display (LCD) panel. The LCD panel includes a color filter substrate, an array substrate, a frame sealant configured to connect the color filter substrate with the array substrate, and a plurality of liquid crystals disposed between the color filter substrate and the array substrate. An alignment film and a plurality of black matrices are disposed on the color filter substrate, a liquid-blocking area is near the frame sealant and is disposed between the black matrices and the alignment film, and the liquid-blocking area is made of a plurality of protrusions which are spaced apart from each other.

Regarding the beneficial effects: in an LCD panel provided by the present disclosure, a liquid-blocking area is near the frame sealant and is disposed between black matrices and the alignment film, and the liquid-blocking area is made of a plurality of protrusions. Because of the protrusions, a flow speed of the liquid PI at a periphery can be reduced. Furthermore, because a plurality of gaps for the liquid PI are disposed between the protrusions, the liquid PI can flow through the gaps and will not accumulate, thereby forming a relatively smooth periphery of the liquid Pl. As a result, the periphery of the display panel does not need to reserve sufficient space for the liquid PI, and a width of the periphery of the liquid PI can be further reduced. As a result, a narrow bezel design can be realized, and a utilization rate of glass increases.

### DESCRIPTION OF DRAWINGS

FIG. 1 is a schematic view showing a coating process of liquid PI in conventional technology.

FIG. 2 is a schematic view showing a periphery of liquid PI in conventional technology.

FIG. 3 is another schematic view showing a periphery of liquid PI in conventional technology.

FIG. 4 is a schematic view showing a structure of an LCD panel in conventional technology.

FIG. 5 is a schematic plan view showing a black matrix layer at a periphery of an LCD panel in conventional technology.

FIG. 6 is a schematic plan view showing a black matrix layer at a periphery of an LCD panel according to an embodiment of the present disclosure.

FIG. 7 is a schematic plan view showing a black matrix layer at a periphery of another LCD panel according to an embodiment of the present disclosure.

FIG. 8 is a schematic plan view showing a black matrix layer at a periphery of yet another LCD panel according to an embodiment of the present disclosure.

### DETAILED DESCRIPTION

Technical solutions will be described with reference to the accompanying drawings to clearly and fully describe objectives, features, and advantages of embodiments of the present disclosure. However, the embodiments of the present disclosure are only some of the embodiments of the present disclosure, but not all of the embodiments. All other embodiments obtained by those skilled in the art based on the embodiments of the present disclosure without creative efforts are within the scope of the present disclosure.

Hereinafter embodiments of the present disclosure will be described in detail with reference to the accompanying drawings. In the drawings, the identical or similar reference numerals constantly denote the identical or similar elements or elements having the identical or similar functions. The embodiments described with reference to the attached drawings are all exemplary and are intended to illustrate and interpret the present disclosure, which shall not be construed as causing limitations to the present disclosure.

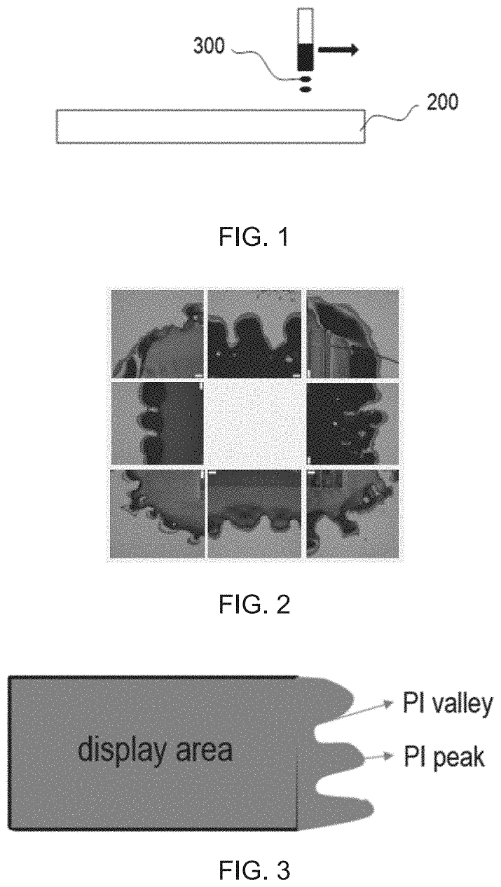

In display panels, a liquid crystal alignment process needs to be realized by a polyimide (Pl) film. Refer to FIG. 1, which is a schematic view showing a coating process of liquid Pl. Liquid PI 300 is coated on a surface of a substrate 200 by inkjet printing to form a PI film. Then, the PI film is heated to make the liquid PI 300 form an alignment film. In the process of forming the alignment film, the liquid PI keeps flowing to a periphery of the substrate after being dropped on the substrate and is cured after a heating process is finished. However, an irregular flow of liquid PI at the periphery of the substrate could easily result in a wavy periphery of a panel, as shown in FIG. 2, which is a schematic view showing a periphery of the PI film in an actual manufacturing process.

To realize an alignment function, peaks and valleys of the liquid PI need to be expanded outside a display area, referring to FIG. 3. However, a periphery of a panel needs to reserve sufficient space for the liquid PI because a width of a wavy liquid PI periphery is usually about 1000 μm, thereby limiting a periphery design of products. As a result, a narrow bezel design cannot be realized, and a utilization rate of a glass is low.

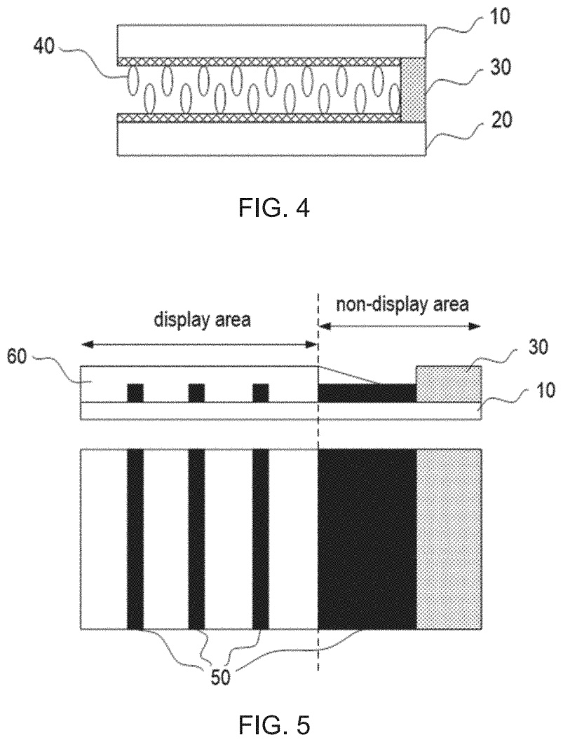

The present disclosure provides an LCD panel 100, as shown in FIG. 4. The LCD panel 100 includes a color filter substrate 10, an array substrate 20, a frame sealant 30, and a plurality of liquid crystals 40. The frame sealant 30 connects the color filter substrate 10 with the array substrate 20, and the liquid crystals 40 are filled between the color filter substrate 10 and the array substrate 20.

As shown in FIG. 5, taking the color filter substrate 10 as an example, the color filter substrate 10 further includes a plurality of black matrices 50 and a PI film 60 (in the present embodiment, the PI film 60 is an alignment film). It should be noted that thicknesses of the black matrices 50 adjacent to the frame sealant 30 are even, and the liquid PI disposed on such a smooth place could easily form a wave-shaped periphery. In FIG. 5, the color filter substrate 10 is divided into a display area and a non-display area, the black matrices 50 are disposed on both the display area and the non-display area, and the liquid PI has not been coated on the color filter substrate 10 (a PI film is not shown). When the liquid PI is coated on the color filter substrate 10, the liquid PI will form the wave-shaped periphery on the black matrices 50 adjacent to the frame sealant 30. To reserve sufficient space for the liquid PI, a width of a non-display area needs to increase. Therefore, a narrow bezel design cannot be realized, and a utilization rate of a glass is low.

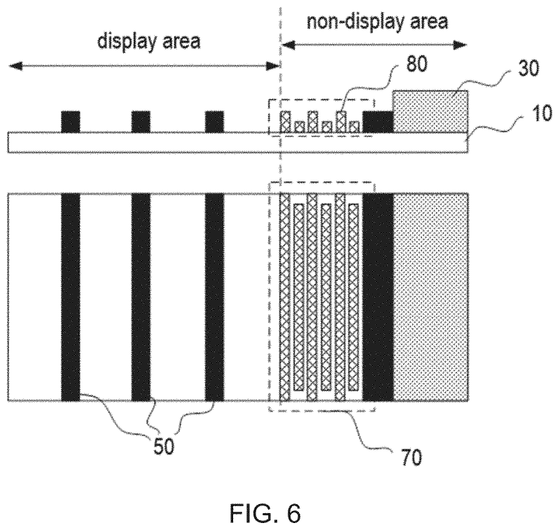

Referring to FIG. 6, the present disclosure provides a color filter substrate 10 (a PI film is not shown) disposed on an LCD panel 100, a liquid-blocking area 70 is further disposed between a plurality of black matrices 50 adjacent to the frame sealant 30 and an alignment film, and the liquid-blocking area 70 is made of a plurality of protrusions 80 which are spaced apart from each other. Because of the protrusions 80, a flow speed of the liquid PI at a periphery of the color filter substrate 10 can be reduced. Furthermore, because a plurality of gaps for the liquid PI are disposed between the protrusions 80, the liquid PI can flow through the gaps and will not accumulate, thereby forming a relatively smooth periphery of the liquid Pl. In the LCD panel 100 provided by the present disclosure, the periphery of the LCD panel 100 does not need to reserve sufficient space for the liquid PI, and a width of the periphery of the liquid PI can be further reduced. As a result, a narrow bezel can be realized, and a utilization rate of glass increases.

It should be noted that the protrusions 80 may be the black matrices 50, indium tin oxide, passivation layers, photoresist materials, array polymers, or metals. In some embodiments, a width of the liquid-blocking area 70 ranges from 200 μm to 3000 μm, thereby forming a display panel with narrow bezels.

In some embodiments, at least two columns of the protrusions 80 are disposed in the LCD panel 100, a gap is disposed between the at least two columns of the protrusions 80, each of the at least two columns comprises one of the protrusions 80, and two ends of the protrusions 80 are near the black matrices 50 adjacent to the frame sealant 30. In some embodiments, at least two columns of the protrusions 80 are disposed in the LCD panel 100, a gap is disposed between the at least two columns of the protrusions 80, each of the at least two columns comprises one of the protrusions 80, and two ends of the protrusions 80 are in contact with the black matrices 50 adjacent to the frame sealant 30. Referring to FIG. 6, some protrusions 80 are in contact with the black matrices 50 adjacent to the frame sealant 30, while some protrusions 80 are near the black matrices 50 adjacent to the frame sealant 30.

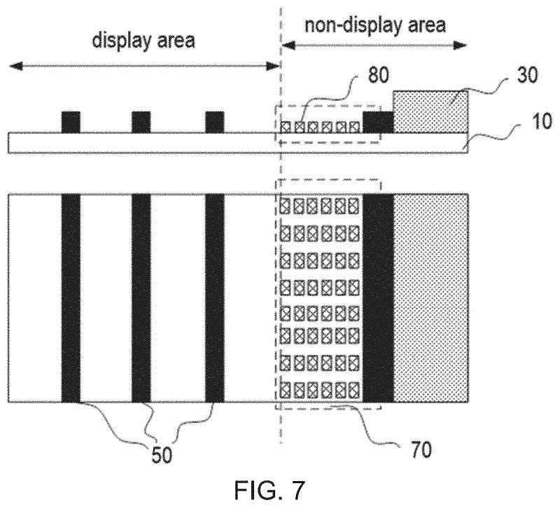

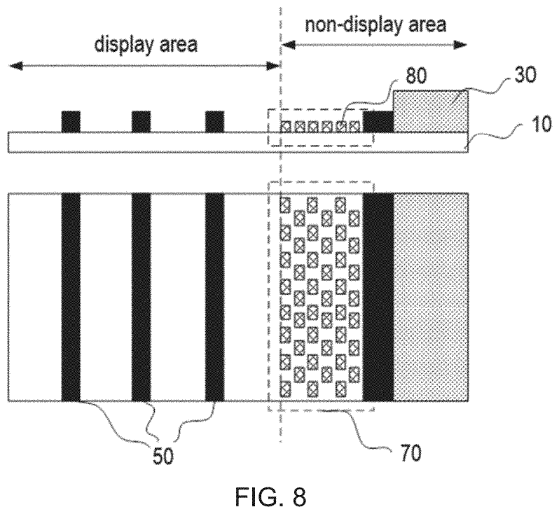

In other embodiments, at least two columns of the protrusions 80 are disposed in the LCD panel 100, a gap is disposed between the at least two columns of the protrusions 80. In such embodiments, each of the at least two columns comprises the plurality of protrusions 80, and a plurality of gaps are disposed between the cubes in a same column. In the present embodiment, the protrusions 80 in different columns may be adjacent to each other, as shown in FIG. 7, while cubes in different columns may also not adjacent to each other, as shown in FIG. 8, and protrusions 80 in the liquid-blocking area 70 form a mosaic.

The present disclosure further provides an LCD panel 100, a height difference does not exist between adjacent protrusions 80, as shown in FIG. 7 and

FIG. 8. In other embodiments, a height difference exists between adjacent protrusions 80, as shown in FIG. 6.

It should be noted that side surfaces of the protrusions 80 as shown in FIG. 6, FIG. 7, and FIG. 8 are rectangular or square, while it should be noted that the protrusions 80 are cubes, and side surfaces of the cubes may be triangular, rectangular, or irregular shapes.

It should be noted that situations in which the protrusions 80 are/are not in contact with the black matrices 50 adjacent to the frame sealant 30, the protrusions 80 in different columns are/are not adjacent to each other, a height difference exists/does not exist between adjacent protrusions 80, and side surfaces of the protrusions 80 are different may simultaneously exist in a single LCD panel.

The present disclosure further provides a display device, including any one of the above LCD panels 100.

In the description of the present disclosure, it should be understood that terms such as “center”, “longitudinal, “lateral, “length, “width, “thickness, “upper, “lower”, “front”, “rear”, “left”, “right”, “vertical”, “horizontal”, “top”, “bottom”, “inside”, “outside”, “clockwise”, “counter-clockwise”, as well as derivative thereof should be construed to refer to the orientation as then described or as shown in the drawings under discussion. These relative terms are for convenience of description, do not require that the present disclosure be constructed or operated in a particular orientation, and shall not be construed as causing limitations to the present disclosure. In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two, unless otherwise specified.

In the description of the present disclosure, it should be noted that unless there are express rules and limitations, the terms such as “mount,” “connect,” and “bond” should be comprehended in broad sense. For example, it can mean a permanent connection, a detachable connection, or an integrate connection; it can mean a mechanical connection, an electrical connection, or can communicate with each other; it can mean a direct connection, an indirect connection by an intermediate, or an inner communication or an interaction between two elements. A person skilled in the art should understand the specific meanings in the present disclosure according to specific situations.

In the description of the present disclosure, unless specified or limited otherwise, it should be noted that, a structure in which a first feature is “on” or “beneath” a second feature may include an embodiment in which the first feature directly contacts the second feature and may also include an embodiment in which an additional feature is formed between the first feature and the second feature so that the first feature does not directly contact the second feature. Furthermore, a first feature “on,” “above,” or “on top of” a second feature may include an embodiment in which the first feature is right “on,” “above,” or “on top of” the second feature and may also include an embodiment in which the first feature is not right “on,” “above,” or “on top of” the second feature, or just means that the first feature has a sea level elevation greater than the sea level elevation of the second feature. While first feature “beneath,” “below,” or “on bottom of” a second feature may include an embodiment in which the first feature is right “beneath,” “below,” or “on bottom of” the second feature and may also include an embodiment in which the first feature is not right “beneath,” “below,” or “on bottom of” the second feature, or just means that the first feature has a sea level elevation less than the sea level elevation of the second feature.

The disclosure herein provides many different embodiments or examples for realizing different structures of the present disclosure. In order to simplify the disclosure of the present disclosure, components and settings of specific examples are described below. Of course, they are only examples and are not intended to limit the present disclosure. Furthermore, reference numbers and/or letters may be repeated in different examples of the present disclosure. Such repetitions are for simplification and clearness, which per se do not indicate the relations of the discussed embodiments and/or settings. Moreover, the present disclosure provides examples of various specific processes and materials, but the applicability of other processes and/or application of other materials may be appreciated by a person skilled in the art.

In the specification, terms such as “some embodiments”, “an embodiment”, and “other embodiments” are intended to describe specific features, structures, materials, or other characteristics in at least one embodiment. In the specification, the above terms are not necessary to denote same embodiments or examples.

Furthermore, specification features, structures, materials, or characteristics mentioned in the specification may be appropriately combined with one or more of embodiments or examples.

Although the present disclosure has been described with a preferred embodiment thereof, the preferred embodiment is not intended to limit the present disclosure. It is understood that many changes and modifications to the described embodiment can be carried out without departing from the scope and the spirit of the disclosure that is intended to be limited only by the appended claims.

1. A liquid crystal display (LCD) panel, comprising a color filter substrate, an array substrate, a sealant configured to connect the color filter substrate with the array substrate, and a plurality of liquid crystals disposed between the color filter substrate and the array substrate;
wherein an alignment film and a plurality of black matrices are disposed on the color filter substrate, a liquid-blocking area is near the sealant and is disposed between the black matrices and the alignment film, the liquid-blocking area is made of a plurality of protrusions which are spaced apart from each other, at least two columns of the protrusions are disposed in the LCD panel, a gap is disposed between the at least two columns of the protrusions, and a height difference does not exist between adjacent protrusions.

2. The LCD panel of claim 1, wherein each of the at least two columns comprises one of the protrusions, and two ends of the protrusions are near or in contact with the black matrices adjacent to the sealant.

3. The LCD panel of claim 1, wherein each of the at least two columns comprises a plurality of the protrusions, and a plurality of gaps are disposed between the protrusions in a same column.

4. A liquid crystal display (LCD) panel, comprising a color filter substrate, an array substrate, a sealant configured to connect the color filter substrate with the array substrate, and a plurality of liquid crystals disposed between the color filter substrate and the array substrate;
wherein an alignment film and a plurality of black matrices are disposed on the color filter substrate, a liquid-blocking area is near the sealant and is disposed between the black matrices and the alignment film, and the liquid-blocking area is made of a plurality of protrusions which are spaced apart from each other.

5. The LCD panel of claim 4, wherein the protrusions are the black matrices, indium tin oxide, passivation layers, photoresist materials, array polymers, or metals.

6. The LCD panel of claim 4, wherein a height difference exists between adjacent protrusions.

7. The LCD panel of claim 4, wherein the protrusions are cubes, and side surfaces of each of the cubes are triangular, rectangular, or irregular shapes.

8. The LCD panel of claim 4, wherein a width of the liquid-blocking area ranges from 200 μm to 3000 μm.

9. The LCD panel of claim 4, wherein at least two columns of the protrusions are disposed in the LCD panel, and a gap is disposed between the at least two columns of the protrusions.

10. The LCD panel of claim 9, wherein each of the at least two columns comprises one of the protrusions, and two ends of the protrusions are near or in contact with the black matrices adjacent to the sealant.

11. The LCD panel of claim 9, wherein each of the at least two columns comprises the plurality of protrusions, and a plurality of gaps are disposed between the protrusions in a same column.

12. The LCD panel of claim 11, wherein the protrusions in different columns are adjacent to each other.

13. A display device, comprising a liquid crystal display (LCD) panel;
wherein the LCD panel comprises a color filter substrate, an array substrate, a sealant configured to connect the color filter substrate with the array substrate, and a plurality of liquid crystals disposed between the color filter substrate and the array substrate; and
wherein an alignment film and a plurality of black matrices are disposed on the color filter substrate, a liquid-blocking area is near the sealant and is disposed between the black matrices and the alignment film, and the liquid-blocking area is made of a plurality of protrusions which are spaced apart from each other.

14. The display device of claim 13, wherein the protrusions are cubes, and side surfaces of each of the cubes are triangular, rectangular, or irregular shapes.

15. The display device of claim 13, wherein at least two columns of the protrusions are disposed in the LCD panel, and a gap is disposed between the at least two columns of the protrusions.

16. The display device of claim 15, wherein each of the at least two columns comprises one of the protrusions, and two ends of the protrusions are near or in contact with the black matrices adjacent to the sealant.

17. The display device of claim 15, wherein each of the at least two columns comprises the plurality of protrusions, and a plurality of gaps are disposed between the protrusions in a same column.

18. The display device of claim 17, wherein the protrusions in different columns are adjacent to each other.
